(19) United States
(12) Patent Application Publication
(10) Pub. No.: US 2026/0337360 A1
(43) Pub. Date: Oct. 29, 2026

(54) METHOD FOR PRODUCING PVC RECYCLATE

(71) Applicant: D&G Recycling GmbH, Nördlingen (DE)

(72) Inventor: Jürgen Deinert, Duderstadt (DE)

(21) Appl. No.: 19/699,384

(22) Filed: Jun. 5, 2026

Related U.S. Application Data
(63) Continuation of application No. PCT/EP2024/085025, filed on Dec. 6, 2024.

(30) Foreign Application Priority Data
Dec. 6, 2023 (EP) 23 214 688.6

(51) Int. Cl. C08J 11/06

(52) U.S. Cl. CPC C08J 11/06; C08J 2327/06

(57) ABSTRACT

A method for producing PVC recyclate from PVC-based plastic particles contaminated with at least one of phthalates, lead compounds, antimony compounds or barium compounds comprises adjusting a particle size of the plastic particles so as to be within a range between 1.0 mm and 10 mm, and treating the plastic particles having the adjusted particle size with a solvent. The solvent comprises at least 75 wt. % in total of one or more solvent constituents selected from acetone, isopropanol or ethoxypropanol, and further comprises an alkaline solubilizing aid. By treating the plastic particles with the solvent, the at least one of phthalates, lead compounds, antimony compounds or barium compounds is extracted from the plastic particles over an extraction period of not more than 6.0 h and at an extraction temperature of not more than 50 °C, while the PVC recyclate remains in the treated plastic particles.

### CROSS REFERENCE TO RELATED APPLICATIONS

This application is a continuation of International Application PCT/EP2024/085025 with an international filing date of Dec. 6, 2024 and claiming priority to European Patent Application No. EP 23 214 688.6 entitled “Verfahren zur Herstellung von PVC-Rezyklat”, filed on Dec. 6, 2023.

### FIELD

The present disclosure relates to a method for producing PVC recyclate from PVC-based plastic particles contaminated with phthalates, lead compounds, antimony compounds and/or barium compounds.

In the production of many products from PVC-based plastics, phthalates have for a long period of time been added to the plastics as plasticizers, and lead, antimony and/or barium compounds have been added as stabilizers or for other purposes. For example, pursuant to the EU REACH Regulation, the aforementioned additives are no longer permissible. This results in difficulties in the recycling of PVC plastics, that is to say in the production of PVC recyclate based on PVC-based plastic particles contaminated with phthalates, lead compounds, antimony compounds and/or barium compounds. This problem will continue to exist in the future, not least because many products imported into the EU from outside the EU will also continue to comprise PVC-based plastics containing additives which are in fact prohibited in the EU.

### BACKGROUND

In a method for separating and recovering target polymers and additives thereof from a polymer-containing material, having the features of the preamble of independent claim 1, is known from WO 2002/014413 A1. In this method, the polymer-containing material is comminuted and subsequently treated with a first solvent, wherein the target polymer is dissolved in the first solvent together with the additives. The dissolved target polymer and the additives present in the same solution are mixed with a second non-aqueous solvent, which is miscible with the first solvent and in which the target polymer is insoluble, in such a manner that the target polymer precipitates while the additives remain in dissolved form. The precipitated target polymer and at least one additive present in the liquid phase are then separated from one another. In the known method, the first solvent dissolving the target polymer and the additives is selected from the group consisting of low-molecular alcohols (C1-C5), cyclic ethers (for example tetrahydrofuran), aliphatic ketones (for example acetone, methyl ethyl ketone) and cyclic ketones (for example cyclohexanone), basic ether mixtures (for example DBE), or a mixture thereof. The second solvent is a low-molecular alcohol. In the separation of plasticizers from flexible PVC, the solvent used for dissolving the target polymer and the additives is tetrahydrofuran or amyl acetate/xylene. In this case, the further solvent is ethanol or, but only in conjunction with THF, hexane. Instead of the second solvent, the known method may employ a solvent system comprising water and a third solvent forming a two-phase system with water. The target polymer is then precipitated in the phase formed by the third solvent, while the additive remains dissolved in this phase. The third solvent is an aliphatic hydrocarbon, for example n-hexane, or an aromatic hydrocarbon, for example toluene. The known method is very time-consuming, since the complete target polymer must first be dissolved in the solvent. In order to accelerate this dissolution, the polymer-containing material is comminuted, a particle size of approximately 2 mm being specified for this purpose. Nevertheless, the known method remains time-consuming, even when the temperature of the solvent is increased. Moreover, it requires large quantities of solvents to be circulated, and the different solvents must be separated from one another and purified. Furthermore, insoluble fillers are separated from the target polymer during dissolution of the target polymer, said fillers having to be re-added upon reuse of the target polymer. Overall, the known method is therefore so complex that it has not yet been implemented on an industrial scale.

JP 2022 093305 A discloses a method for producing PVC recyclate. PVC-based plastic particles having a particle size <5 mm, which contain, in addition to PVC, phthalates as plasticizers and fillers, inter alia barium sulfate, are treated with isopropanol at 25 °C or 50 °C for 15 to 60 minutes while being stirred. The liquid-to-solid ratio (volume/weight) is from 3 to 10.

KR 2023 0142157 A discloses a method for producing PVC recyclate, in which PVC waste containing lead-containing stabilizers and phthalates as plasticizers is comminuted and treated at 50 °C for one hour while being stirred.

There still is a need of a method by means of which a PVC recyclate usable also within the EU is obtained in a cost-effective manner from PVC-based plastic particles contaminated with phthalates, lead compounds, antimony compounds and/or barium compounds.

### SUMMARY OF THE INVENTION

The present invention relates to a method for producing PVC recyclate from PVC-based plastic particles contaminated with at least one of phthalates, lead compounds, antimony compounds or barium compounds. The method comprises adjusting a particle size of the plastic particles so as to be within a range between 1.0 mm and 10 mm, and treating the plastic particles having the adjusted particle size with a solvent. The solvent comprises at least 75 wt. % in total of one or more solvent constituents selected from acetone, isopropanol or ethoxypropanol, and further comprises an alkaline solubilizing aid. By treating the plastic particles with the solvent, the at least one of phthalates, lead compounds, antimony compounds or barium compounds is extracted from the plastic particles over an extraction period of not more than 6.0 h and at an extraction temperature of not more than 50 °C, while the PVC recyclate remains in the treated plastic particles.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a flow diagram illustrating the sequence of the method according to the present disclosure.

### DETAILED DESCRIPTION

In the method according to the present disclosure for producing PVC recyclate from plastic particles contaminated with phthalates, lead compounds, antimony compounds and/or barium compounds, a particle size of the plastic particles is adjusted within a range between 1.0 mm and 10 mm. The plastic particles having the adjusted particle size are treated with a solvent, wherein the solvent consists of at least 75 percent by weight of acetone, isopropanol and/or ethoxypropanol. By the treating with the solvent, the phthalates, lead compounds, antimony compounds and/or barium compounds are extracted from the plastic particles having the particle size over an extraction period of not more than 6.0 h and at an extraction temperature of not more than 50 °C, wherein the PVC recyclate remains in the extracted plastic particles.

Even though the method according to the present DISCLOSURE employs solvents similar or even identical to those used in the method known from WO 2002/014413 A1, unlike therein, they are not used for dissolving the target polymer. Rather, the extraction conditions are adjusted such that the PVC recyclate to be produced remains in the plastic particles treated with the solvent. These conditions include the extraction period of at most six hours and the extraction temperature of at most 50 °C. In this way, the disturbing phthalates, lead compounds, antimony compounds and/or barium compounds are selectively extracted from the plastic particles in the method according to the present disclosure, while not only the PVC itself, but also fillers and similarly sparingly soluble additives remain in the plastic particles and thus in the recyclate, which would otherwise have to be re-added upon reuse of the PVC.

It is surprising that, using fundamentally the same solvents as those described in WO 2002/014413 A1 as solvents not only for dissolving the additives but also the target polymer, phthalates, lead compounds, antimony compounds and/or barium compounds, which are hereinafter also collectively referred to as contaminants, can be selectively dissolved out from the plastic particles without dissolving substantial quantities of the PVC. Moreover, it is surprising that a single-stage extraction of the plastic particles with the solvent is sufficient to extract all of the aforementioned contaminants from the plastic particles to such an extent that the PVC recyclate remaining in the plastic particles becomes at least sufficiently free of these contaminants for the recyclate also to be usable within the EU, that is to say in conformity with the REACH Regulation, for the production of new products.

The solvent comprises an alkaline solubilizing aid. The alkaline solubilizing aid may in particular be sodium hydroxide, but may also, for example, be potassium hydroxide. The extraction period can be substantially shortened by hydroxide ions (OH—) dissociated in the solvent. Starting from a pH value of approximately 9, or respectively a pOH value, which is defined as the negative decadic logarithm of the concentration of dissociated hydroxide ions, wherein in aqueous solutions pH+pOH=14, of approximately 5, both hydrolysis of the phthalates and an improvement in the solubility of lead and antimony compounds occur. It is therefore advantageous to adjust, by means of the alkaline solubilizing aid, a pH value of the solvent of more than 9.0 for the extraction, or more precisely a pOH value of not more than 5.0. More preferably, the pOH value of the solvent is adjusted during the treating to not more than 3.0, even more preferably to not more than 1.0, and most preferably to 0, by means of the alkaline solubilizing aid. It should be taken into consideration that the higher the concentration of hydroxide ions (OH—) in the solution, the lower the pOH value. When all hydroxide ions (OH—) present are dissociated, a pOH value of 0 corresponds to a concentration of sodium hydroxide of 4 wt. %. Typically, the solvent comprises up to 5 wt. % of the alkaline solubilizing aid.

Preferably, the solvent used in the extraction in the method according to the present DISCLOSURE consists of at least 80 percent by weight of acetone, isopropanol or ethoxypropanol. Particularly preferably, it consists of at least 80 percent by weight of acetone. The aforementioned solvents are readily and safely manageable and at the same time have a limited environmental hazard potential and are comparatively inexpensive.

The solvent used in the extraction in the method according to the present DISCLOSURE may comprise up to 20 percent by weight of a cosolvent, which may consist of water, ethanol and/or other hydrocarbon compounds. The other hydrocarbon compounds may in particular be aliphatic hydrocarbon compounds. Preferably, these comprise six to nine carbon atoms. By means of the cosolvent, the polarity of the solvent can be adjusted such that the relevant contaminants are extracted particularly effectively. For example, a higher polarity of the solvent increases the extraction rate of lead and barium salts, whereas a reduced polarity increases the extraction rate of the phthalates.

The particle size adjusted for the plastic particles determines their relative surface area across which the extraction takes place and the length of the diffusion paths to be overcome during the extraction. Smaller plastic particles are therefore extractable within shorter extraction periods than larger plastic particles. At the same time, however, the risk of loss of PVC, that is to say dissolution of PVC during the extraction, increases as the size of the plastic particles decreases. Therefore, the particle size of the plastic particles is preferably adjusted to at least 2.0 mm and more preferably to at least 3.0 mm, and preferably to not more than 6.0 mm and more preferably to not more than 5.0 mm. It is particularly preferred for all plastic particles to have a particle size that is as uniform as possible, since the further process conditions of the extraction can then be precisely matched to this particle size. It is therefore advantageous to adjust the particle size of the plastic particles with a maximum tolerance of +/−1.5 mm. Preferably, the particle size is adjusted with a maximum tolerance of +/−1.0 mm and even more preferably with a maximum tolerance of +/−0.5 mm.

In the method according to the present disclosure, the extraction period is preferably not more than 5.0 hours, more preferably not more than 4.0 hours, and most preferably not more than 3.0 hours. Frequently, it amounts to approximately 2 hours. The extraction temperature is preferably at least 0 °C and more preferably at least 10 °C. Preferably, the extraction temperature is at most 40 °C and more preferably at most 30 °C. At this comparatively low extraction temperature, the extraction proceeds in a controlled manner, that is to say limited to the contaminants to be removed and without substantial loss of PVC.

A weight ratio of the plastic particles to the solvent during the treating, that is to say the extraction, is typically not greater than 1:4 and preferably not greater than 1:9. In other words, the plastic particles constitute at most 20 percent by weight and preferably at most 10 percent by weight of the suspension of the plastic particles suspended in the solvent. At the same time, the weight ratio of the plastic particles to the solvent is typically not less than 1:99 and preferably not less than 1:60. In other words, the plastic particles constitute at least 1 percent by weight and preferably at least 1.7 percent by weight of the suspension. In any case, the solvent is employed in a substantial excess relative to the plastic particles in order to effectively extract the contaminants. In order to maintain the concentration difference of the contaminants between the plastic particles and the solvent as high as possible, the solvent may be stirred with the plastic particles during the extraction. Alternatively or additionally, during the extraction, the solvent may be exchanged at least once for fresh solvent of the same composition or of a different composition, or may be conducted through a reactor in countercurrent to the plastic particles. The concentration difference constitutes the driving force acting on the contaminants in the direction out of the plastic particles.

If, after the treating with the solvent, the plastic particles are subjected to a pressure reduced by at least 500 hPa relative to normal pressure, the solvent can thereby be completely evaporated and in this way completely removed from the plastic particles. The contaminants can be separated again from the solvent by filtration with activated carbon and/or by distillation at reduced pressure and/or elevated temperature. The solvent reprocessed in this manner can be reused for extracting the contaminants from the plastic particles.

The method according to the present disclosure is in particular carried out in such a manner that the contaminants are removed from the plastic particles solely by the treating with the solvent to such an extent that the PVC recyclate remaining in the plastic particles contains less than 0.1 percent by weight phthalates, less than 0.1 percent by weight lead compounds, less than 0.1 percent by weight antimony compounds and less than 0.1 percent by weight barium compounds. Consequently, the PVC recyclate can be used within the EU in accordance with the REACH Regulation for the production of new products made from PVC.

Specifically, the plastic particles from which the contaminants have been extracted by the extraction according to the present disclosure may be used directly, optionally in conjunction with aggregates, as starting material for new products. However, the extracted plastic particles may also previously be further processed in order to obtain a PVC recyclate having even further improved properties.

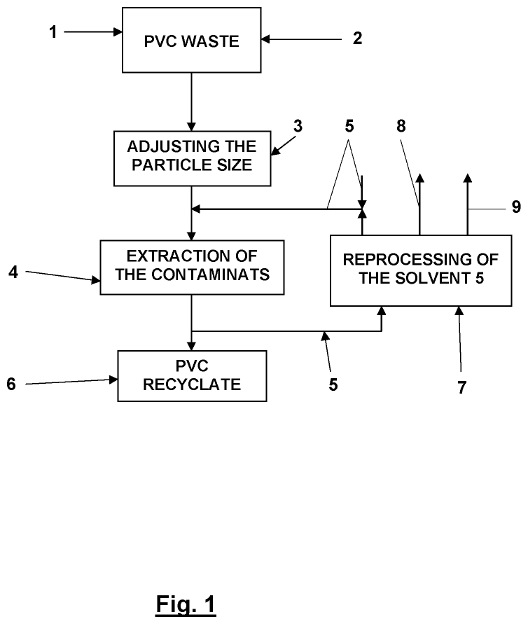

Referring now in greater detail to the drawings, FIG. 1 depicts he method illustrated in the form of a flow diagram in FIG. 1 serves for processing PVC waste 1 in the form of PVC-based plastic particles 2. The PVC-based plastic particles contain fillers and other additives which are useful for recycling, but also contaminants which must be removed prior to recycling. These contaminants include in particular phthalates, which were used as plasticizers in PVC compounds, as well as lead compounds, antimony compounds and barium compounds, which were used as stabilizers for PVC plastics. In order to remove these contaminants, an adjusting 3 of the particle size of the plastic particles 2 is initially carried out by comminution and/or sieving. The aim is a particle size of all plastic particles that is as uniform as possible in a preferred range from 2.0 mm to 6.0 mm and with a preferred deviation of the particle size of not more than +/−1.0 mm from a mean particle size. In an extraction 4, the plastic particles 2 having the adjusted particle size are treated with solvent 5 in order to extract the aforementioned contaminants. The extraction 4 is conducted in such a manner that a PVC recyclate 6 intended for reuse remains in the extracted plastic particles, while the contaminants dissolve in the solvent 5 and can be separated from the plastic particles 2 together with the solvent 5. The PVC recyclate 6 contains, in addition to PVC, fillers and other additives which not only do not impede reuse of the PVC recyclate 6, but are even useful for such reuse. During a reprocessing 7 of the solvent 5, the phthalates 8 and the lead, antimony and barium compounds 9 are separated from the solvent 5 by fractional distillation, after which the solvent is returned to the extraction 4.

In the examples documented below, the plastic particles respectively adjusted to a particle size of 2 to 5 mm were suspended in the respective solvent at a weight ratio of 1:19 and extracted with the solvent while being stirred, wherein the solvent loaded with the contaminants was continuously discharged, purified and returned to the extraction. After the specified extraction period at the specified extraction temperature, the respective contaminants had all been removed from the plastic particles to below 0.1 wt. %, such that a reusable PVC recyclate remained in the plastic particles.

Comparative Examples 1 and 2 relating to Examples 1 and 2 demonstrate that, by the addition of 1 wt. % sodium hydroxide as an alkaline solubilizing aid, such that a pOH value of less than 1.0 is established in the solvent, the extraction period can be significantly shortened by one eighth without deterioration of the extraction. In Examples 3 and 4, the 4 wt. % sodium hydroxide added as solubilizing aid results in a pOH value of 0 for the solvent.

### Example 1

Material: PVC-P (plasticized polyvinyl chloride) from cable recyclate, ground material 2-5 mm
Concentration: 5 wt. % in the solvent
Initial contaminant content: 22.2 wt. % phthalates, 3.2 wt. % lead stearate
Solvent: 79.2 wt. % ethoxypropanol, 19.8 wt. % hexane
Alkaline solubilizing aid: 1 wt. % sodium hydroxide
Extraction temperature: 40 °C
Extraction period: 105 min
Residual contaminant content: <0.1 wt. % phthalates, <0.1 wt. % lead stearate

### Comparative Example 1

Material: PVC waste from cable recyclate, ground material 2-5 mm
Concentration: 5 wt. % in the solvent
Initial contaminant content: 22.2 wt. % phthalates, 3.2 wt. % lead stearate
Solvent: 80 wt. % ethoxypropanol, 20 wt. % hexane
Extraction temperature: 40 °C
Extraction period: 120 min
Residual contaminant content: <0.1 wt. % phthalates, <0.1 wt. % lead stearate

### Example 2

Material: PVC-P from tarpaulins, defibered, ground material 2-5 mm
Concentration: 5 wt. % in the solvent
Initial contaminant content: 32.1 wt. % phthalates, 1.8 wt. % lead stearate 0.9 wt. % lead oxide, 1.9 wt. % antimony oxide
Solvent: 89.1 wt. % acetone, 9.9 wt. % ethanol
Alkaline solubilizing aid: 1 wt. % sodium hydroxide
Extraction temperature: 30 °C
Extraction period: 135 min
Residual contaminant content: <0.1 wt. % phthalates, <0.1 wt. % lead stearate <0.1 wt. % lead oxide, <0.1 wt. % antimony oxide

### Comparative Example 2

Material: PVC-P from tarpaulins, defibered, ground material 2-5 mm
Concentration: 5 wt. % in the solvent
Initial contaminant content: 32.1 wt. % phthalates, 1.8 wt. % lead stearate 0.9 wt. % lead oxide, 1.9 wt. % antimony oxide
Solvent: 90 wt. % acetone, 10 wt. % ethanol
Extraction temperature: 30 °C
Extraction period: 150 min
Residual contaminant content: <0.1 wt. % phthalates, <0.1 wt. % lead stearate <0.1 wt. % lead oxide, <0.1 wt. % antimony oxide

### Example 3

Material: PVC-P from floor covering, ground material 2-5 mm
Concentration: 5 wt. % in the solvent
Initial contaminant content: 36.2 wt. % phthalates, 1.9 wt. % lead stearate 2.6 wt. % antimony oxide
Solvent: 96 wt. % isopropanol
Alkaline solubilizing aid: 4 wt. % sodium hydroxide
Extraction temperature: 20 °C
Extraction period: 180 min
Residual contaminant content: <0.1 wt. % phthalates, <0.1 wt. % lead stearate <0.1 wt. % antimony oxide

### Example 4

Material: PVC-P from hoses with PET reinforcing fabric, ground material 2-5 mm
Concentration: 5 wt. % in the solvent
Initial contaminant content: 48.0 wt. % phthalates, 0.6 wt. % lead stearate
Solvent: 96 wt. % ethoxypropanol
Alkaline solubilizing aid: 4 wt. % sodium hydroxide
Extraction temperature: 50 °C
Extraction period: 150 min
Residual contaminant content: <0.1 wt. % phthalates, <0.1 wt. % lead stearate

Many variations and modifications may be made to the preferred embodiments of the invention without departing substantially from the spirit and principles of the invention. All such modifications and variations are intended to be included herein within the scope of the present invention, as defined by the following claims.

I claim:

1. A method for producing PVC recyclate from PVC-based plastic particles contaminated with at least one of phthalates, lead compounds, antimony compounds or barium compounds, the method comprising:
adjusting a particle size of the plastic particles so as to be within a range between 1.0 mm and 10 mm; and
treating the plastic particles having the adjusted particle size with a solvent,
wherein the solvent comprises at least 75 wt. % in total of one or more solvent constituents selected from acetone, isopropanol or ethoxypropanol, and further comprises an alkaline solubilizing aid, and
wherein, by treating the plastic particles with the solvent, the at least one of phthalates, lead compounds, antimony compounds or barium compounds is extracted from the plastic particles over an extraction period of not more than 6.0 h and at an extraction temperature of not more than 50 °C, while the PVC recyclate remains in the treated plastic particles.

2. The method of claim 1, wherein the solvent comprises at least 80 wt. % in total of the one or more solvent constituents selected from acetone, isopropanol or ethoxypropanol.

3. The method of claim 2, wherein the solvent comprises at least 80 wt. % acetone.

4. The method of claim 1, wherein the solvent further comprises from 0 to 20 wt. % of at least one cosolvent selected from water, ethanol or one or more hydrocarbon compounds.

5. The method of claim 4, wherein the one or more hydrocarbon compounds are aliphatic hydrocarbon and comprise 6 to 9 carbon atoms.

6. The method of claim 4, wherein the solvent comprises at least 5.0 wt. % of the cosolvent.

7. The method of claim 1, wherein the alkaline solubilizing aid comprises sodium hydroxide.

8. The method of claim 1, wherein the alkaline solubilizing aid adjusts a pH value of the solvent to greater than 9.0 during the treating.

9. The method of claim 1, wherein the alkaline solubilizing aid adjusts a pOH value of the solvent to not more than 5.0 during the treating.

10. Method of claim 9, wherein the alkaline solubilizing aid adjusts the pOH value of the solvent during the treating to not more than 1.0.

11. The method of claim 1, wherein the solvent comprises up to 5 wt. % of the alkaline solubilizing aid.

12. The method of claim 1,
wherein the particle size is adjusted so as to be at least 2.0 mm and to not more than 6.0 mm, and
wherein the particle size is adjusted with a maximum tolerance of +/−1.0 mm.

13. The method of claim 1, wherein the extraction period is not more than 4.0 h.

14. The method of claim 1, wherein the extraction temperature is at least 10 °C and not more than 30 °C.

15. The method of claim 1, wherein a weight ratio of the plastic particles to the solvent during the treating is not greater than 1:9 and not less than 1:60.

16. The method of claim 1, wherein, during the treating, the solvent is at least one of
stirred with the plastic particles or
guided in countercurrent to the plastic particles.

17. The method of claim 1, wherein, after the treating, the plastic particles are subjected to a pressure reduced by at least 500 hPa relative to normal pressure to completely remove the solvent.

18. The method of claim 1, wherein, after the treating, the solvent is reprocessed to remove the at least one of phthalates, antimony compounds or barium compounds contained therein, and is subsequently reused for the treating.

19. The method preceding claim 1, wherein the at least one of phthalates, lead compounds, antimony compounds or barium compounds is separated from the solvent by at least one of
filtration with activated carbon or
distillation at at least one of reduced pressure or elevated temperature.

20. The method of claim 1, wherein the at least one of phthalates, lead compounds, antimony compounds or barium compounds is removed from the plastic particles exclusively by the treating with the solvent, and wherein the PVC recyclate obtained contains less than 0.1 wt. % phthalates, less than 0.1 wt. % lead compounds, less than 0.1 wt. % antimony compounds, and less than 0.1 wt. % barium compounds.
